(19) United States
(12) Patent Application Publication
(10) Pub. No.: US 2004/0247282 A1
(43) Pub. Date: Dec. 9, 2004

(54) Methods and systems for storing multiple video information

(76) Inventors: Tsuneo Nishi, Aichi-ken (JP); Yoshiyasu Watanabe, Aichi-ken (JP); Tetsuya Hattori, Aichi-ken (JP)

Correspondence Address: Douglas J. Christensen, Patterson, Thuente, Skaar & Christensen, P.A., 4800 IDS Center, 80 South Eighth Street, Minneapolis, MN, 55402-2100, US

(21) Appl. No.: 10/864,101

(22) Filed: Jun. 9, 2004

(30) Foreign Application Priority Data
Jun. 9, 2003 (JP) 2003-163780

(51) Int. Cl. H04N 5/781

(52) U.S. Cl. 386/46; 386/125

(57) ABSTRACT

A method of storing video information, i.e., video data, transmitted to a control unit via a plurality of communication paths is disclosed. The method comprises the steps of (a) providing a first memory means in the respective communication paths connected to the control unit, and (b) storing the video information in the first memory means. The video information is transmitted to the first memory means via the respective communication paths. The first memory means acts as a buffer system allowing the storage of multiple image frames. The method further comprises the steps of (c) reading the video data stored in the first memory means in units of a predetermined quantity; and (d) storing the units of read video information in a second memory means.

This application claims priority to Japanese patent application serial number 2003-163780, the contents of which are incorporated herein by reference.

### BACKGROUND OF THE INVENTION

1. Field of the Invention

The present invention relates to methods and devices for storing video information transmitted from a plurality of imaging devices via a plurality of transmission paths, without skipping a frame(s) or with a minimum of skipping frame(s) of a video data set.

2. Description of the Related Art

In a known video data storing system shown in FIG. 8, video data is simultaneously picked up by a plurality of cameras (cameras 1, 3, and 5, in FIG. 8). A switching device 31 may select (switch) the video data from one of these cameras. An operator may actuate the switching device 31 at a desired time through the manual operation of an input device 13. The switching device 31 may also be automatically actuated at some predetermined time interval (such as 10 seconds). A compression device 7 then compresses the selected data. The compressed data is transferred to a control unit 15 and subsequently stored in random access memory (RAM) 15b via a central processing unit (CPU) 15a, The CPU 15a reads the compressed data stored in RAM 15b. The CPU 15a then transfers the read compressed data for storage on a hard disk drive (HDD) 17. The control unit 15 may read the compressed video data stored on the HDD 17 in order to reproduce the compressed video data for a desired time period set by the manual operation of the input device 13. Otherwise, the control unit 15 may automatically read the compressed video data stored on the HDD 17 in order to reproduce the compressed video data automatically only for a period set by a timer. The control unit 15 transfers the read compressed video data to a decompression (uncompression) device 19 for decompressing (uncompressing) the read compressed video data. The uncompressed data is displayed (reproduced) on a display device 25. Japanese Laid-Open Patent Publication No. 11-1144 teaches a multiple video data storage system configured in this manner.

However, in the known video data storage system, the switching device 31 selects (switches) the video data transmitted from just one of cameras 1, 3, and 5, for subsequent storage on the HDD 17. Therefore, only the selected video data is stored on the HDD 17 and the other video data may not be stored on the HDD 17. This presents a problem for reviewing all of the video captured from multiple perspectives at a single point in time.

### SUMMARY OF THE INVENTION

It is accordingly an object of the present invention to teach improved techniques for storing all of the video information transmitted from a plurality of imaging devices.

According to one aspect of the present teachings, methods are taught of storing video information, i.e., video image data sets, transmitted to a control unit via a plurality of communication paths. The methods comprise the steps of:

(a) providing first memory means in the communication paths connected to the control unit; and

(b) storing the video data in the first memory means, wherein the video data is received by the first memory means via the communication paths; and

(c) reading the video data stored in the first memory means; and

(d) storing the read video data in second memory means.

Therefore, the video information transmitted via the communication paths is initially stored in the first memory means. The video information stored in the first memory means may be read and then stored in the second memory means. Therefore, even if more than one set of video information is simultaneously transmitted via the plurality of transmission paths, the video information from all of the transmission paths may be stored in the second memory.

In another aspect of the present teachings, the methods further comprise the steps of reading the video information stored in the second memory means and displaying the read video information on a display means.

In another aspect of the present teachings, step (c) is performed by reading the video information in quantities of a unit, for example, units comprising a predetermined number of image frames and/or a predetermined period of time. The video information may be read from the first memory means in quantities of first units. Therefore, the video information stored in the first memory means may be stored in the second memory means in an orderly and predetermined fashion by the quantities of first units.

In another aspect of the present teachings, step (c) further comprises allocating addresses to the video information read from the first memory means.

In another aspect of the present teachings, the second memory means comprises a hard disk drive.

In another aspect of the present teachings, the methods further comprise storing the read video information in a third memory means after step (c) and then reading the video information stored in the third memory means in quantities of second units from the third memory means. The step (d) comprises storing the read video information unit from the third memory means in the second memory means.

Therefore, the video information read from the first memory means is subsequently stored in the third memory means. The video information stored in the third memory is then read from the third memory in quantities of second units (for example, units comprising a predetermined number of image frames and/or a predetermined time period), and then stored in the second memory means. As a result, the available storage regions of the second memory means can be effectively and efficiently utilized.

In another aspect of the present teachings, the second units are a predetermined number of image frames that are determined so as to correspond to a storage region of the second memory means. The correspondence would allow the efficient and effective use of an entire storage region due to an appropriately determined second unit configuration.

In another aspect of the present teachings, the second memory means comprises a hard disk drive and the third memory means comprises RAM.

In another aspect of the present teachings, the video information represents images taken or captured by a plurality of imaging devices, such as cameras.

In another aspect of the present teachings, the video information comprises a first video data set of an image in front of an automobile and second video data set of an image of an interior of the automobile.

In another aspect of the present teachings, the methods further comprise the step of compressing the video information before step (b). Therefore the video information is stored in the first memory means after compression. Subsequently, the amount of video information that can be stored in the second memory can be increased.

In another aspect of the present teachings, the methods further comprise reading the compressed video data stored in the second memory means and decompressing the read video data. Therefore, the uncompressed video data can be used display on a display device.

In another aspect of the present teachings, the methods further comprise displaying the uncompressed video data on a display means, for example, a monitor or TV screen.

In another aspect of the present teachings, systems for carrying out the above methods are taught. The systems comprise a control unit; a plurality of communication paths connected to the control unit; first memory means disposed in the communication paths, and second memory means connected to the control unit. The first memory means serves to store the video data that is received by the first memory means via the respective communication paths. The second memory means serves to store the video data read from the first memory means via the control unit. The control unit functions to read the video data stored in the first memory means and to transmit the read video data to the second memory means.

In another aspect of the present teachings, the systems further comprise a third memory means arranged and constructed to store the read video data. The control unit serves to read the video information stored in the third memory means in quantities of second units and to store the read video data from the third memory means in the second memory means.

In another aspect of the present teachings, the second memory means comprises a hard disk drive and a third memory means comprises RAM.

In another aspect of the present teachings, the systems further comprise a compression means disposed in the communication paths that serve to compress the video data prior to transmitting the video data to the first memory means.

In another aspect of the present teachings, the systems further comprise decompression means for decompressing the video data. The control unit serves to read video data stored in the second memory means and to uncompress the read video data by the decompression means.

In another aspect of the present teachings, the systems further comprise display means arranged and constructed to display the uncompressed video data.

### BRIEF DESCRIPTION OF THE DRAWINGS

FIG. 1 is a block diagram showing a first representative video image storing system; and

FIG. 2 is a time chart illustrating the times and sequence of reading and storing the video data in the first representative video image storing system; and

FIG. 3 is a block diagram showing a second representative video image storing system; and

FIG. 4 is a block diagram showing a third representative video image storing system; and

FIG. 5 is a time chart illustrating the times and sequence of reading and storing the video data in the third representative video image storing system; and

FIGS. 6(A) and 6(B) are views illustrating the storage regions of a HDD;

FIG. 7 is a block diagram showing a fourth representative video image storing system; and

FIG. 8 is a block diagram showing a known video image storing system.

### DETAILED DESCRIPTION OF THE INVENTION

Each of the additional features and teachings disclosed above and below may be utilized separately or in conjunction with other features and teachings to provide improved methods and systems for storing video data. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### First Representative Embodiment

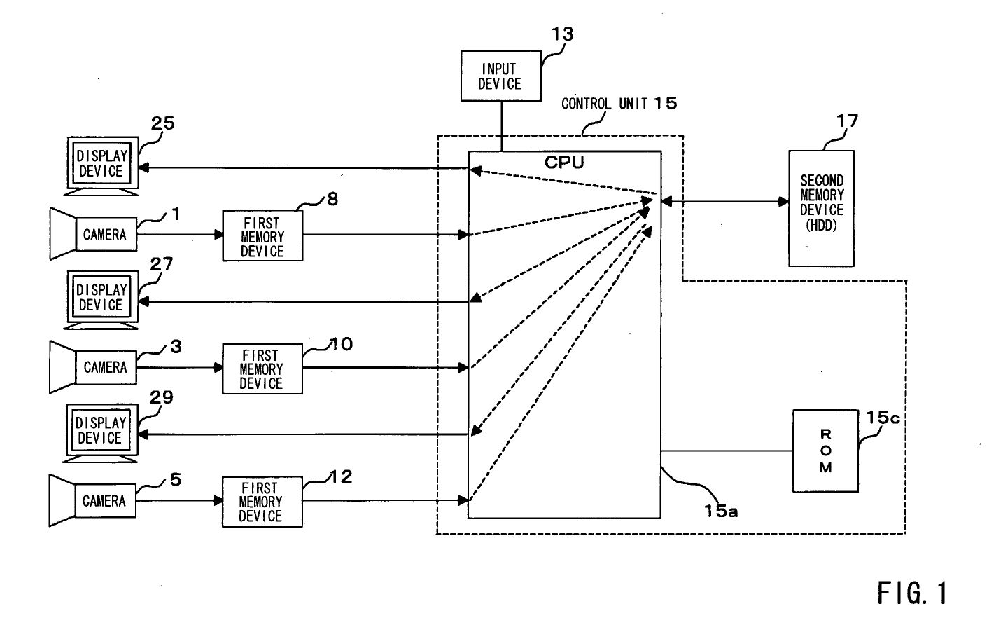

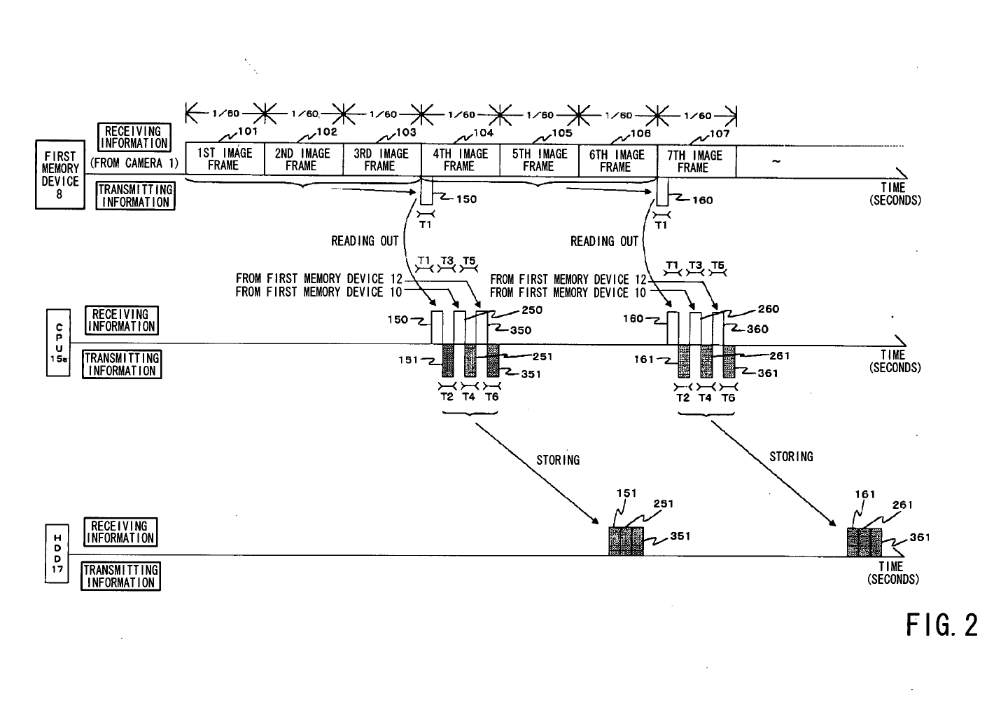

A first representative embodiment of the present invention will now be described with reference to FIGS. 1 and 2.

General Construction

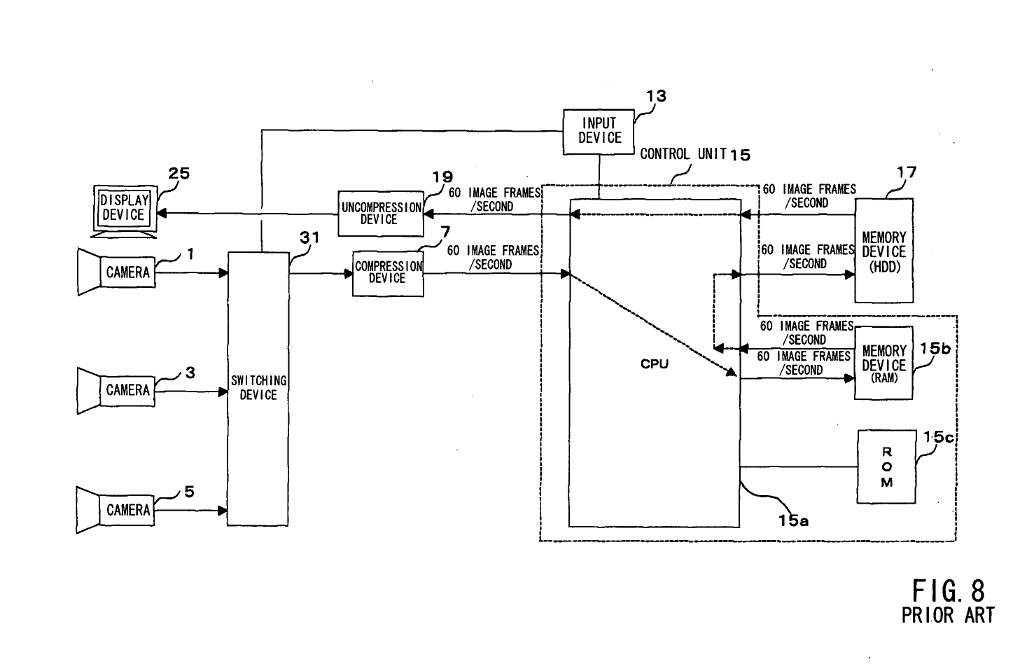

A general construction will now be described with reference to FIG. 1, in which for the purposes of illustration, parts that are similar in function with parts of the known video recording device shown in FIG. 8 are labeled with the same reference numerals as the parts of the known video recording device. Referring to FIG. 1, there is shown a schematic block diagram of three imaging devices 1, 3, and 5, and a representative system for storing first, second, and third video information (hereinafter called “first, second, and third, video data sets”) that has been captured, taken, created, or picked up, by the respective imaging devices 1, 2, and 3. The imaging devices 1, 2, and 3, may be surveillance cameras or video cameras. The imaging devices will be hereinafter generally referred to as “cameras.” The cameras 1, 3, and 5, are electrically connected to a control unit 15 respectively via first memory devices 8, 10, and 12. The control unit 15 is electrically connected to an input device 13 and to a second memory device 17. For example, the second memory device 17 may be a magnetic storage media or an optical storage media. The representative embodiment will be described for the situation where the second memory device 17 is preferably configured as a HDD (hard disk drive), i.e., a magnetic storage media. The second memory device 17 will hereinafter be referred to as “HDD 17.” The operator provides recording instructions for the control unit 15 by means of the input device 13. The control unit 15 functions so as to store onto the HDD 17 the first, second, and third video data sets transmitted from respective cameras 1, 3, and 5. The control unit 15 includes a computing section 15a and ROM 15c. In this representative embodiment, a CPU substantially configures the computing section 15a, The computing section 15a will be hereinafter referred to as “CPU 15a.” The ROM 15c contains a control program so that the CPU 15a reads the first, second, and third video data sets stored in the memory devices 8, 10, and 12. The CPU 15a then transfers the read video data to the HDD 17 so that the first, second, and third video data sets are stored on the HDD 17.

Three display devices 25, 27, and 29, are electrically connected to the control unit 15. When the operator inputs display instructions (reproducing instructions) to the control unit 15 by means of the input device 13, the control unit 15 transmits the first, second, and third video data sets stored on the HDD 17 to the respective display devices 25, 27, and 29, according to the display instructions. The first, second, and third video data sets are displayed on their respective display devices 25, 27, and 29. The details of the system and operation for storing (recording) the first, second, and third video data sets and the details of the system and operation for displaying the first, second, and third video data sets will now be described.

Video Data Storing System

The system for storing onto the HDD 17 the first, second, and third video data sets captured by cameras 1, 3, and 5, will be described with reference to FIGS. 1 and 2. FIG. 2 is a time chart illustrating the time and general sequence followed when the memory device 8, the CPU 15a, and the HDD 17, transmit and/or receive the video data. In this representative embodiment, each of the cameras 1, 3, and 5, can pick up 60 continuous image frames per second. In other words, each of the cameras 1, 3, and 5, can transmit one image frame each to the corresponding memory device 8, 10, and 12 during 1/60 second. Therefore, as camera 1 starts to capture images, camera 1 may also serially transmit video data block 101 (video data corresponding to the first image frame), video data block 102 (video data corresponding to the second image frame), video data block 103 (video data corresponding to the third image frame), and so on, to the memory device 8 at time intervals of 1/60 of a second per image frame. Consequently, the memory device 8 sequentially receives the video data blocks 101, 102, 103, etc., from camera 1. Memory device 8 may function as a type of buffer, allowing the storage of multiple image frames from camera 1. The CPU 15a reads the stored blocks of video data 101, 102, 103, etc., in discrete units corresponding to a predetermined time period (e.g., 0.05 second) or a predetermined number of frames (e.g., three frames). In this representative embodiment, the CPU 15a reads the stored video data in units containing three sequential image frames (three data blocks). The CPU 15a reads a video data unit 150 of three stored video data blocks, e.g., video data blocks such as 101, 102, and 103, each time that three new video data blocks are stored in memory 8. However, in order to store three video data blocks, e.g., the video data blocks such as 101, 102, and 103, memory 8 requires 3/60 (1/20) of a second. CPU 15a, on the other hand, only requires time T1 (seconds) in order to read a video data unit 150. Therefore, the relationship 3/60>T1” may be likely.

Each time the CPU 15a reads a video data unit 150, the CPU 15a transmits the video data unit 150 to the HDD 17 as an address-allocated video data unit 151. Here, in the address-allocated video data unit 151, the three blocks of video data, e.g., the video data blocks 101, 102, and 103, of video data unit 150, are allocated separate addresses, such as “A01”, “A02”, and “A03”. The addresses allow the CPU 15a to later identify the three video data blocks for subsequent processing. Thus, the CPU 15a identifies and stores the video data blocks 101, 102, and 103, in the order of “A01 (video data block 101)”, “A02 (video data block 102)” and “A03 (video data block 103)”, on corresponding sectors of the HDD 17. The CPU 15a requires the time T2 (seconds) in order to store one address-allocated video data unit 151.

The video data from camera 3 may be stored in substantially the same manner as the video data from camera 1. Thus, when the camera 3 starts to capture (pick up) video images, camera 3 may also transmit video data block 201 (video data corresponding to the first image frame), video data block 202 (video data corresponding to the second image frame), video data block 203 (video data corresponding to the third image frame), and so on, to the memory device 10 at approximate time intervals of 1/60 of a second per data block. Consequently, memory device 10 sequentially receives the video data blocks 201, 202, 203, etc., from camera 3. Memory device 10 may function as a type of buffer, allowing the storage of multiple image frames from camera 3. The CPU 15a reads the stored blocks of video data 201, 202, 203, etc., in discrete units corresponding to a predetermined period of time and/or a predetermined number of frames. As described in connection with camera 1, in this representative embodiment the CPU 15a reads the stored video data in discrete units corresponding to three image frames per unit. The CPU 15a reads three blocks of stored video data, e.g., the video data blocks 201, 202, and 203, as a video data unit 250, each time three video data blocks are stored in memory 10. In order to store three blocks of video data, e.g., the video data blocks 201, 202, and 203, the memory 10 requires 3/60 (1/20) of a second. On the other hand, the CPU 15a requires time T3 (seconds) in order to read a video data unit 250. Therefore, the relationship “3/60>T3” may exist.

Each time the CPU 15a reads a video data unit 250, the CPU 15a transmits the video data unit 250 to the HDD 17 as an address-allocated video data unit 251. Here, in the address-allocated video data unit 251, three blocks of video data, e.g., such as the video data blocks 201, 202, and 203, of the video data unit 250 are allocated specific addresses, such as “B01”, “B02” and “B03”. The addresses allow the CPU 15a to later identify the three video data blocks for subsequent processing. Thus, the CPU 15a identifies and stores the video data blocks 201, 202, and 203, in the order of “B01 (video data block 201)”, “B02 (video data block 202)”, and “B03 (video data block 203)”, on corresponding sectors of the HDD 17. The CPU 15a requires the time T4 (seconds) in order to store one address-allocated video data unit 251.

The video data from camera 5 may be stored in substantially the same manner as the video data from camera 1 and camera 3. Thus, when camera 5 starts to capture images, camera 5 may also serially transmit video data blocks 301 (video data corresponding to the first image frame), video data block 302 (video data corresponding to the second image frame), video data block 303 (video data corresponding to the third image frame), and so on, to memory device 12 at time intervals of 1/60 of a second per data block. Consequently, the memory device 12 sequentially receives the video data blocks 301, 302, 303, etc., from camera 5. Memory device 12 may function as a type of buffer, allowing the storage of multiple image frames from camera 5. The CPU 15a reads the stored video data blocks 301, 302, 303, etc., in individual units comprised of predetermined periods of time and/or predetermined numbers of frames. As previously described in connection with the camera 1, in this representative embodiment the CPU 15a reads the stored blocks of video data preferably in units of three image frames per unit. Thus, the CPU 15a reads three stored blocks of video data, e.g., such as the video data blocks 301, 302, and 303, as a video data unit 350, each time three video data blocks are stored in memory 12. In order to store three blocks of video data, e.g., the video data 301, 302, and 303, memory 12 requires 3/60 (1/20) of a second. The CPU 15a, on the other hand, requires time T5 (seconds) in order to read a video data unit 350. Therefore, the relation “3/60>T5” may be likely.

Each time the CPU 15a reads a video data unit 350, the CPU 15a transmits the video data unit 350 to the HDD 17 as an address-allocated video data unit 351. Here, in the address-allocated video data unit 351, three blocks of video data, e.g., the video data blocks 301, 302, and 303, of the video data unit 350, are allocated distinct addresses, such as “C01”, “C02”, and “C03”. The addresses allow the CPU 15a to later identify the three video data blocks for subsequent processing. Thus, the CPU 15a identifies and stores the blocks of video data 301, 302, and 303, in the order of “C01” (video data block 301)”, “C02 (video data block 302)” and “C03 (video data block 303)”, on corresponding sectors of the HDD 17. The CPU 15a requires the time T6 (seconds) in order to store one address-allocated video data unit 351.

The CPU 15a is not configured to simultaneously read the video data units 150, 250, and 350, from their respective memory devices 8, 10, and 12. The CPU 15a is also not configured to simultaneously store the address-allocated data units 151, 251, and 351, to the HDD 17. Instead, the program stored in ROM 15c causes the CPU 15a to read the data stored in the memory devices 8, 10, and 12, in a predetermined order. For example, the CPU 15a may read the data in the following order: initially memory device 8, then memory device 10, and finally memory device 12. The CPU 15a can generally read and store faster than the rate of image frame transmission of the cameras. Therefore, since the CPU 15a deals in units of three image frames (taking a total of 3/60 to transmit from the cameras), as long as the condition “T1+T2+T3+T4+T5+T6<3/60 (second)” may be satisfied, no image frames will be skipped during the storing of three video data sets. The video data of the forth and subsequent image frames may be stored in additional units of three image frames per unit in the same manner as the first to third image frames described above. Therefore, the explanation of the storing (recording) process of the forth image frame and subsequent image frames will not be necessary.

Video Data Displaying System

The system for displaying video data set 101, 102, 103, etc., video data set 201, 202, 203, etc., and video data set 301, 302, 303, etc., (stored as individual units on the HDD 17 in the manner described above), on the respective display devices 25, 27, and 29, will now be described. When the operator inputs display instructions (reproducing instructions) to the control unit 15 via the input device 13, the CPU 15a starts to read the video data stored in the HDD 17. In this representative embodiment, the video data captured by camera 1 is displayed on display device 25, the video data captured by camera 3 is displayed on display device 27, and the video data captured by camera 5 is displayed on display device 29. The “A” addresses, i.e., the addresses “A01”, “A02”, “A03”, etc., are allocated to the video data 101, 102, 103, etc., captured by camera 1. Therefore, the CPU 15a can identify and read the camera 1 video data, to which the “A” addresses are allocated, from the HDD 17. The read video data is then transmitted and displayed on the corresponding display device 25.

Similarly, the “B” addresses, i.e., the addresses “B01”, “B02”, “B03”, etc., are correspondingly allocated to the video data 201, 202, 203, etc., captured by camera 3. Therefore, the CPU 15a can identify and read the camera 3 video data, to which the “B” addresses are allocated, from the HDD 17. The read video data is then transmitted and displayed on the corresponding display device 27. Also similarly, the “C” addresses, i.e., the addresses “C01”, “C02”, “C03”, etc., are allocated to the video data 301, 302, 303, etc., captured by camera 5. Therefore, the CPU 15a can identify and read the video data to which the “C” addresses are allocated, from the HDD 17. The read video data is then transmitted and displayed on the corresponding display device 29.

In this way, the CPU can identify the video data set based upon the addresses allocated to the various blocks of video data, so that the video data set 101, 102, 103, etc., the video data set 201, 202, 203, etc., and the video data set 301, 302, 303, etc., can be displayed on the corresponding display devices 25, 27, and 29, as desired by the operator.

### Second Representative Embodiment

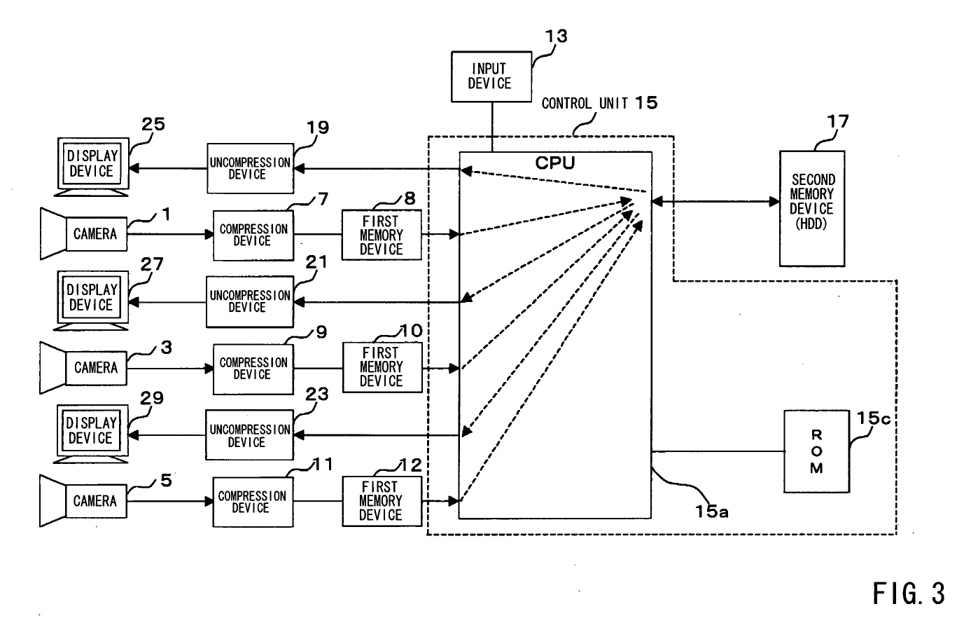

A second representative embodiment of the present invention will now be described with reference to FIG. 3.

General Construction

The second representative embodiment is configured to store video data taken or obtained (captured) by cameras 1, 3, and 5. The video data is stored in the respective memory devices 8, 10, and 12, after the video data has been compressed. Therefore, the system of the second representative embodiment primarily differs from the first representative embodiment in that the system of the second representative embodiment additionally includes compression devices 7, 9, and 11, and decompression devices 19, 21, and 23. As shown in FIG. 3, cameras 1, 3, and 5, are respectively electrically connected to memory devices 8, 10, and 12, via the compression devices 7, 9, and 11. In addition, the displays 25, 27, and 29, are respectively electrically connected to the control unit 15 via the decompression devices 19, 21, and 23. The other construction is generally the same as the system of the first representative embodiment.

Video Data Storing System

The system for storing the video data to the HDD 17 of the second representative embodiment is generally the same as the system for storing the video data for the first representative embodiment, with an exception of the video data being stored in memory devices 8, 10, and 12, after compression. By compressing the video data, it is possible to shorten the time required by the CPU 15a to process the video data. For example, if the compression devices 7, 9, and 11, compress the video data by 50%, the time required by the CPU 15a for processing (reading and/or storing) the video data may be shortened by 50%. Therefore, if the maximum ability of the CPU 15a to process uncompressed video data is limited to three cameras, after the video data is compressed by 50% the same CPU 15a may be used for processing the compressed video data from as much as six cameras. From another viewpoint, if the maximum ability of the CPU 15a to store uncompressed video data on the HDD 17 is limited to 100,000 image frames, the same CPU 15a can be used for storing up to 200,000 image frames of compressed video data on the HDD 17 if the video data is compressed by 50%. Therefore, by incorporating the compression devices 7, 9, and 11, the CPU 15a can store more video data on the HDD 17.

Video Data Displaying System

In the second representative embodiment, the compressed video data stored on the HDD 17 is uncompressed by the decompression devices 19, 21, and 23. The uncompressed video data sets are then displayed on the respective display devices 25, 27, and 29. In other respects, the display system of the second representative embodiment is generally the same as the display system of the first representative embodiment.

### Third Representative Embodiment

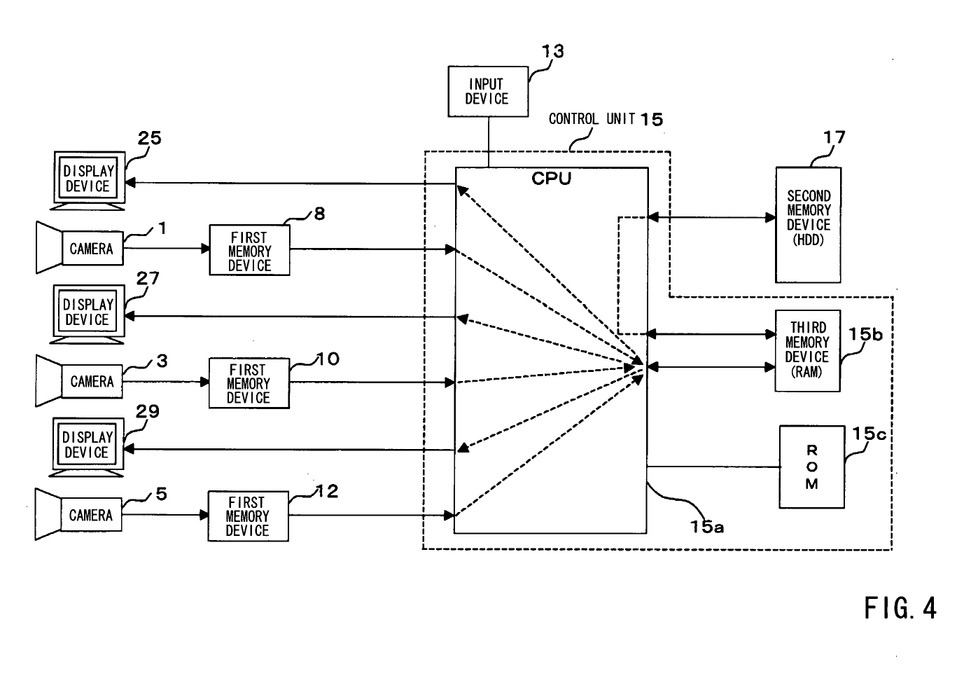

A third representative embodiment of the present invention will now be described with reference to FIGS. 4 to 6.

General Construction

In order for the CPU 15a to store the video data set on the HDD 17, the CPU 15a stores the video data set in a third memory device 15b. The CPU 15a then reads the video data from the third memory device 15b and stores the read video data on the HDD 17. In this representative embodiment, RAM preferably constitutes the third memory device 15b. Therefore, the third memory device 15b will be hereinafter referred to as “RAM 15b.” The system of the third representative embodiment is different from the system of the first representative embodiment primarily in the addition of the RAM 15b to the system. As seen from a block diagram shown in FIG. 4, the control unit 15 includes the RAM 15b. The RAM 15b is electrically connected to the CPU 15a, The other construction is generally the same as in the first representative embodiment.

Video Data Storing System

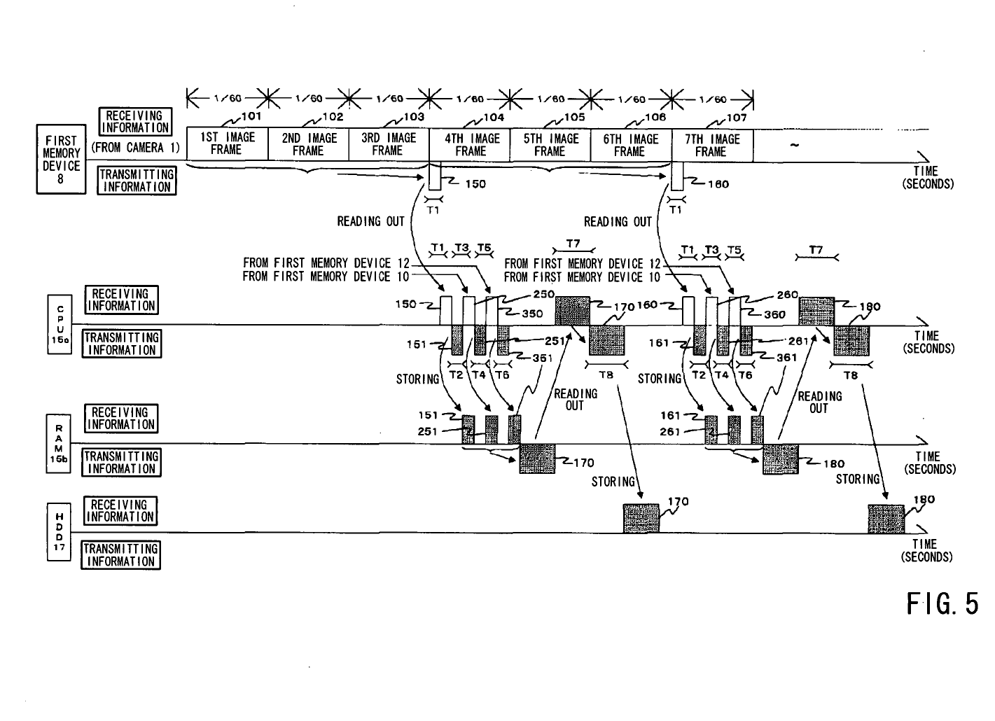

The system for storing the video data sets captured by cameras 1, 3, and 5, onto the HDD 17 will now be described with reference to FIGS. 4 and 5. FIG. 5 is an explanatory view illustrating the times and general sequence of events occurring when the memory device 8, the CPU 15a, the RAM 15b, and the HDD 17, transmit and receive the video data. The system of the third representative embodiment for reading the video data units 150, 250, and 350, from the respective memory units 8, 10, and 12, by the CPU 15a is essentially the same as in the first representative embodiment. Therefore, an explanation of the reading system will not be necessary. However, the system for the operations subsequent to the reading operation will be hereinafter described.

The system for storing the video data transmitted from camera 1 will be described initially. Each time the CPU 15a reads a video data unit 150, the CPU 15a transmits the video data unit 150 to the RAM 15b as the address-allocated video data unit 151. The RAM 15b stores the address-allocated video data unit 151. As described previously, in this embodiment the address-allocated video data unit 151 preferably contains three video data blocks, e.g., the video data blocks 101, 102, and 103, of the video data unit 150. The video data blocks of unit 151 are allocated different addresses, such as “A01”, “A02”, and “A03”, so that the CPU 15a can later identify the three video data blocks for subsequent processing. Thus, the CPU 15a identifies and stores the video data 101, 102, and 103, in the order of “A01 (video data block 101)”, “A02 (video data block 102)” and “A03 (video data block 103)”, in the corresponding sectors of the RAM 15b. The CPU 15a requires time T2 (seconds) in order to store one address-allocated video data unit 151.

The system and the operation for storing the video data set transmitted from camera 3 are substantially the same as the system and operation described above in connection with camera 1. Each time the CPU 15a reads a video data unit 250, the CPU 15a transmits the video data unit 250 to the RAM 15b as the address-allocated video data unit 251. The RAM 15b stores the address-allocated video data unit 251. In the address-allocated video data unit 251, three video data blocks, e.g., the video data 201, 202, and 203, of the video data unit 250, are allocated distinct addresses, such as “B01”, “B02”, and “B03”. The distinct addresses enable the CPU 15a to identify the three video data blocks later for subsequent processing. Thus, the CPU 15a identifies and stores the video data 201, 202, and 203, in the order of “B01 (video data block 201)”, “B02 (video data block 202)” and “B03 (video data block 203)”, in the corresponding sectors of RAM 15b. The CPU 15a requires time T4 (seconds) to store one address-allocated video data unit 251.

The system and the operation for storing the video data set transmitted from camera 5 are also substantially the same as the system and operation described above in connection with camera 1. Each time the CPU 15a reads a video data unit 350, the CPU 15a transmits the video data unit 350 to the RAM 15b as the address-allocated video data unit 351. The RAM 15b stores the address-allocated video data unit 351. In the address-allocated video data unit 351, three video data blocks, e.g., the video data blocks 301, 302, and 303, of the video data unit 350, are allocated unique addresses, such as “C01”, “C02”, and “C03”. The addresses allow the CPU 15a to be able to later identify the three video data blocks for subsequent processing. Thus, the CPU 15a identifies and stores the video data blocks 301, 302, and 303, in the order of “C01 (video data block 301)”, “C02 (video data block 302)” and “C03 (video data block 303)”, in the corresponding sectors of the RAM 15b. The CPU 15a requires time T6 (seconds) to store one address-allocated video data unit 351.

The address-allocated video data units 151, 251, and 351, that were received from the memory devices 8, 10, and 12, and stored in the RAM 15b, are read by the CPU 15a as consolidated video data 170. The CPU 15a then stores the consolidated video data 170 on the HDD 17. The third memory device essentially acts as a secondary buffer allowing the storage of multiple address-allocated video data units. The CPU 15a requires time T7 (seconds) to read the consolidated video data 170 from the RAM 15b. In addition, the CPU 15a requires time T8 (seconds) to store the consolidated video data 170 onto the HDD 17.

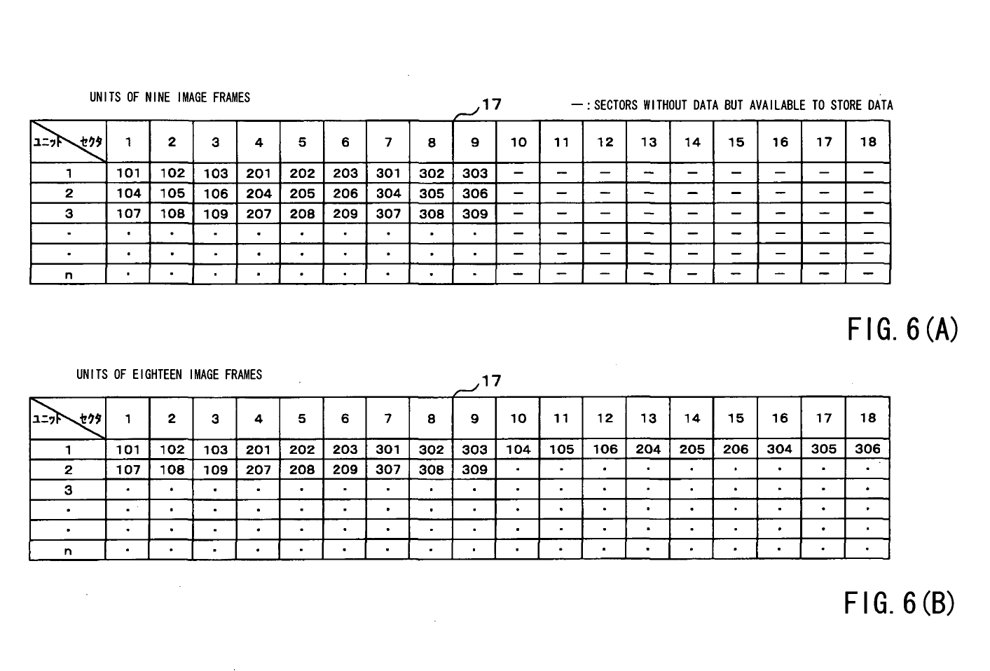

The CPU 15a reads the consolidated video data 170 from the RAM 15b in units of a predetermined number of image frames or a predetermined time period of data. In this representative embodiment shown in FIG. 5, the CPU 15a reads the consolidated video data 170 in units of nine image frames per unit. As shown in FIG. 6(A), the HDD 17 may have a storage region that includes n units each divided into 18 sectors. The CPU 15a stores the video data on the HDD 17 in order starting from the first sector of the first unit to the 18^{th} sector of the n^{th} unit. For the purposes of explanation, the m^{th} sector of the n^{th} unit will be hereinafter represented by “n/m.” Therefore, the first sector of the first unit may be represented by “1/1” and the 18^{th} sector of the nth unit may be represented by “n/18.” Thus, the CPU 15a stores the video data in the order of sectors “1/1” to “1/18”, “2/1” to “2/18”, . . . , “n/1” to “n/18.” More specifically, when the CPU 15a reads the consolidated video data 170, the CPU 15a respectively stores the video data blocks 101, 102, 103, 201, 202, 203, 301, 302, and 303, in HDD 17 sectors “1/1”, “1/2”, “1/3”, “1/4”, “1/5”, “1/6”, “1/7”, “1/8” and “1/9”. Similarly, when the CPU 15a reads a second unit of consolidated video data 180, the CPU 15a respectively stores video data blocks 104, 105, 106, 204, 205, 206, 304, 305, and 306, in the HDD 17 sectors “2/1”, “2/2”, “2/3”, “2/4”, “2/5”, “2/6”, “2/7”, “2/8”, and “2/9”. In a similar way, the subsequent video data blocks 107, 108, 109, 207, 208, 209, 307, 308, and 309, are respectively stored in the HDD 17 sectors “3/1”, “3/2”, “3/3”, “3/4”, “3/5”, “3/6”, “3/7”, “3/8”, and “3/9”. Additional subsequent video data blocks are stored in a similar manner.

Because the CPU 15a reads the video data from the RAM 15b in units of nine images per unit and stores the video data in the HDD 17 sectors as described above, the sectors “1/10” to “1/18”, “2/10” to “2/18”, “3/10” to “3/18”, and so on, may not store any video data blocks although they are available for storing video data blocks. Therefore, the video storage system cannot effectively or efficiently utilize the entire storage region of the HDD 17.

In order to overcome this problem and improve the effectiveness of the storage, the CPU 15a may be programmed to read the video data from the RAM 15b in units corresponding to storage configuration of the memory device, in this embodiment, the CPU 15a would preferably read a unit composed of 18 image frames as, shown in FIG. 6(B). Thus, the video data blocks 101, 102, and 103, are respectively stored in sectors “1/1”, “1/2”, and “1/3”, and the video data blocks 104, 105, and 106, are respectively stored in the sectors “1/10”, “1/11”, and “1/12”. In a similar way, the video data blocks 201, 202, and 203, are respectively stored in the sectors “1/4”, “1/5”, and “1/6”, and the video data blocks 204, 205, and 206, are respectively stored in the sectors “1/13”, “1/14”, and “1/15”. In addition, the video data blocks 301, 302, and 303, are respectively stored in the sectors “1/7”, “1/8”, and “1/9”, and the video data blocks 304, 305, and 306, are respectively stored in the sectors “1/16”, “1/17”, and “1/18”. The video data block 107 and subsequent video data blocks, the video data block 207 and subsequent video data blocks, and the video data block 307 and subsequent video data blocks may be stored in the similar ways. For an additional example of the sequencing, the video data blocks 107, 108, and 109, are respectively stored in the sectors “2/1”, “2/2” and “2/3”, and the video data block 309 is stored in the sector “2/9.”

By instructing the CPU 15a to cause the CPU 15a to read the video data from the RAM 15b in units of 18 image frames per unit as described above, unused memory sectors may be eliminated. Therefore, the available memory region of the HDD17 can be effectively used by having the unit quantity read by the CPU 15a correspond to the available memory region of the HDD 17.

The CPU 15a is not configured to simultaneously perform the following functions: the reading operation of the video data units 150, 250, and 350, from the respective memories 8, 10, and 12; the storing operation of these video data units in the RAM 15b; the reading operation of the video data units stored in the RAM 15b; and the storing operation of the address-allocated video data units 151, 251, and 351. Therefore, a program may be contained in the ROM 15c, such that (1) the CPU 15a reads the video data blocks stored in the memory devices 8, 10, and 12, in a predetermined order (e.g., in the order of 1-memory device 8, 2-memory device 10 and 3-memory device 12) and then stores the address-allocated video data 151, 251, and 351, in the RAM 15b; and (2) the CPU 15a subsequently reads the consolidated video data 170 from the RAM 15b and stores the consolidated video data 170 on the HDD 17.

The video data sets transmitted from cameras 1, 3, and 5, are respectively read by the CPU 15a in units of three image frames per unit. The consolidated video data units read by the CPU 15a from the RAM 15b are composed of three address-allocated video data units of three image frames per address-allocated video data units. Therefore, a total number of nine image frames are stored on the HDD 17 at a single time via the RAM 15b. If time relation “T1+T2+T3+T4+T5+T6+T7+T8<3/60 (seconds)” is satisfied, no image frames will be skipped. The fourth and subsequent image frames from each of the cameras 1, 3, and 5, are processed in units of three image frames per unit in the same general manner as with the processing of the first to third image frames. As a result, the continued processing will not be further explained in detail.

Video Data Displaying System

In essentially the same manner as in the first representative embodiment, the CPU 15a reads the video data stored on the HDD 17 in order to display the video data. However, in the third representative embodiment, the CPU 15a stores the video data read from the HDD 17 in the RAM 15b. The CPU 15a then reads the video data stored in the RAM 15b in order to display the video data set on a corresponding or desired display device 25, 27, and 29. Because the CPU 15a reads the video data from the HDD 17 via the RAM 15b, the CPU 15a can manipulate the video data that was stored in the RAM 15b. For example, if it is desired to display the first video data set captured by camera 1 on all three display devices 25, 27, and 29, the CPU 15a may initially read the address-allocated video data captured by camera 1 from the HDD 17. The address-allocated video data is then stored in the RAM 15b. Subsequently, the CPU 15a may produce a triplicated reproduction of the read video data set allowing the display devices 25, 27, and 29, to each display a reproduction of the first video data set captured by camera 1. For example, one image frame is read from the RAM 15b, it may be reproduced as three image frames, and if nine image frames are read, they may be reproduced as twenty-seven image frames.

### Fourth Representative Embodiment

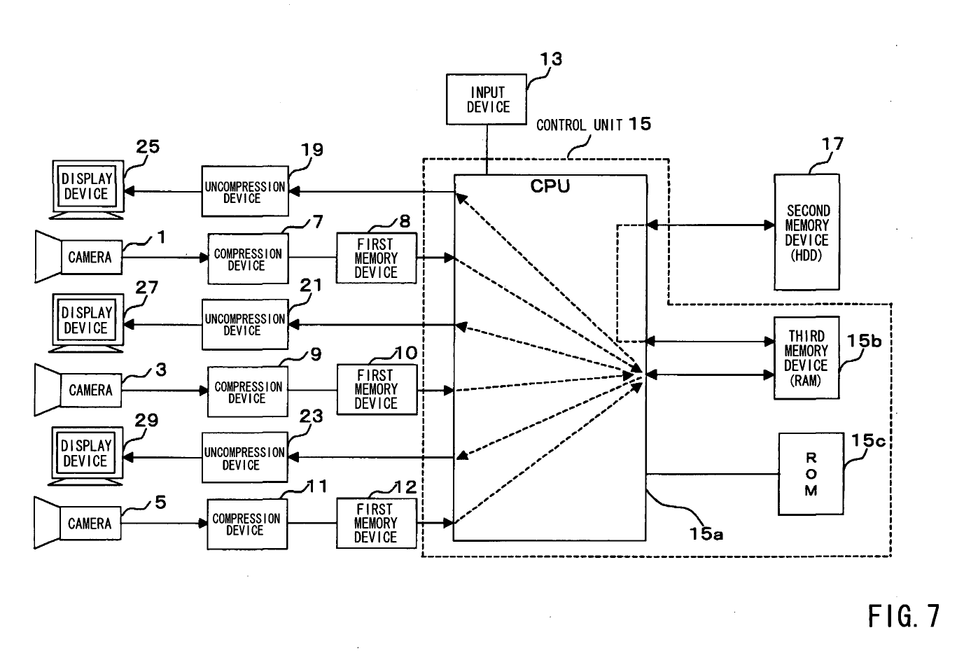

A fourth representative embodiment of the present invention will now be described with reference to FIG. 7.

General Construction

The fourth representative embodiment is configured so that the CPU 15a stores the compressed video data in RAM 15b prior to storing the compressed video data on the HDD 17. Thus, the CPU 15a reads the compressed video data stored in the RAM 15b and then stores the compressed video data on the HDD 17. Therefore, the fourth representative embodiment is different from the first representative embodiment essentially in the addition of compression devices 7, 9, and 11, decompression devices 19, 21, and 23, and the RAM 15b. In other words, the fourth representative embodiment may be generally considered as a combination of the second and third representative embodiments.

As shown in the block diagram of FIG. 7, the cameras 1, 3, and 5, are respectively electrically connected to the memory devices 8, 10, and 12, via the compression devices 7, 9, and 11. The display devices 25, 27, and 29, are respectively electrically connected to the control unit 15 via the decompression devices 19, 21 and 23. The control unit 15 includes the RAM 15b that is electrically connected to the CPU 15a, In most other respects, the construction of the fourth representative embodiment is the same as the construction of the first representative embodiment.

Video Data Storing System

The fourth representative embodiment's system for storing the video data to the HDD 17 via the RAM 15b by the CPU 15a is generally the same as the system of the third representative embodiment. An exception is that the video data stored in the HDD 17 is video data previously compressed by the compression devices 7, 9, and 11, and then stored in the respective memory devices 8, 10, and 12. The remainder of the storing operation is essentially the same as previously described and therefore will not be further described in detail.

According to the fourth representative embodiment, the CPU 15a can store a larger amount of the video data in the HDD 17 due to the incorporation of the compression devices 7, 9, and 11. In addition, the CPU 15a buffers the video data in the RAM 15b prior to storing the video data in the HDD 17. Therefore, when the RAM 15b is incorporated as a secondary buffer, the number of image frames that can be stored in the HDD 17 by each access of the HDD 17 is greater than the number of image frames that can be stored in the HDD 17 by each access of the HDD 17 when the RAM 15b is not incorporated. When using compressed video data, it is also not necessary to frequently move or as drastically move the head of the HDD 17 in order to store the same amount of video data in the HDD 17 as in a system using uncompressed video data. That is, it is possible to reduce the number of times required to operate the head of the HDD 17 in order to seek a sector in which the data is to be stored. As a result, the video data can be more efficiently stored.

Video Data Displaying System

According to the fourth representative embodiment, the video data sets provided for the display devices 25, 27, and 29, are the compressed video data sets stored on the HDD 17. After the reading of the compressed video data sets stored on the HDD 17 and storage in the RAM 15b, the CPU 15a operates to read the compressed data sets from the RAM 15b. The CPU 15a operates to transmit the compressed video data sets to the display devices 25, 27, and 29. Prior to the compressed video data sets actual display in the display devices 25, 27, and 29, the compressed video data sets are uncompressed by a decompression device. In most other respects, the displaying system is generally the same as the displaying system of third representative embodiment in which the CPU 15a operates to transmit the video data sets previously stored in the RAM 15b for display in the display devices 25, 27, and 29.

### Possible Applications of Representative Embodiments

As an example of an application of the first to third representative embodiments, the cameras 1, 3, and 5, may be mounted on a vehicle, such as an automobile. Camera 1 may be positioned to capture an image in front of the automobile, camera 3 may be positioned to capture an image of a front seat, such as a driver's seat or a passenger's seat, and camera 5 may be positioned to capture an image of a rear seat. By positioning the cameras 1, 3, and 5, in this way, video data sets of the automobile taken up by cameras 1, 3, and 5, can be used for testing. The control unit 15, the HDD 17, the compression devices 7, 9, and 11, and optionally the decompression devices 19, 21, and 23, may also be mounted to the automobile or may be disposed at a fixed station for communication with the cameras via radio waves.

### Possible Alternative Arrangements of First to Third Representative Embodiments

The present invention may not be limited to the above representative embodiments but may be modified in various ways. The following are possible alternative arrangements:

(1) Although the control unit 15 and the HDD 17 are configured as separate members from each other, they may be combined into an integrated unit.

(2) Although the compression devices 7, 9, and 11, are configured as separate devices from the decompression devices 19, 21, and 23, they may be configured as integrated compression and decompression devices.

(3) Although video images are transmitted from each of the compression devices 7, 9, and 11, at a speed of sixty image frames per second, such transmitting speeds may be different for each of the compression devices 7, 9, and 11.

(4) The memory devices 8, 10, and 12, may be respectively disposed within the compression devices 7, 9, and 11, or the memory devices 8, 10, and 12, may be disposed within the control unit 15.

(5) The video data may be stored in the HDD 17 (first memory device) and the RAM 15b (second memory device) by a controller separate from the CPU 15a. Such a separate controller may be a type of dedicate controller for inputting and outputting information, which is known as a “memory access controller”.

(6) The numeral values disclosed in connection with the first to third representative embodiments should be considered only as examples and are not intended to limit the present invention.

(7) Although the representative embodiments have been described in connection with the systems having three cameras and three display devices, four or more cameras and four or more display devices may be used. In addition, the number of the display devices may be different from the number of the cameras.

(8) Although magnetic and optical memory devices are considered in the representative embodiments, holographic and flash memory products may also be used for storing of the video data sets.

This invention claims:

1. A method of storing video information transmitted to a control unit via a plurality of communication paths, comprising:
(a) providing a first memory means in the communication paths connected to the control unit; and
(b) storing the video information in the first memory means, wherein the video information is transmitted to the first memory means via the communication path; and
(c) reading the video information stored in the first memory means; and
(d) storing the read video information in a second memory means.

2. The method as in claim 1, wherein the step (c) is performed by reading the video information in quantities of first units

3. The method as in claim 2, wherein each first unit is a predetermined number of image frames.

4. The method as in claim 2, wherein the video information is stored in the second memory in quantities of the first units.

5. The method as in claim 2, further comprising a step of;
allocating addresses to the video information read from the first memory means.

6. The method as in claim 1, wherein the second memory means comprises a hard disk drive.

7. The method as in claim 1, further comprising steps of:
storing the video information read from the first memory means in a third memory means; and
reading the video information stored in the third memory means in quantities of second units; and
wherein the read video information in step (d) comprises the video information in quantities of second units read from the third memory means.

8. The method as in claim 7, wherein each second unit is a predetermined number of image frames.

9. The method as in claim 8, further comprising determining the predetermined number of image frames so as to correspond to a storage region of the second memory means.

10. The method as in claim 9, wherein the second memory means comprises a hard disk drive, and
wherein the third memory means comprises RAM.

11. The method as in claim 1, wherein the video information represents images captured by a plurality of cameras.

12. The method as in claim 11, wherein the video information comprises a first video information of an image in front of an automobile, and a second video information of an image of an interior of the automobile.

13. The method as in claim 1, further comprising the step of;
compressing the video information.

14. The method as in claim 13, further comprising the steps of;
reading the compressed video information stored in the second memory means, and
decompressing the read video information.

15. The method as in claim 14, further comprising displaying the uncompressed video information on display means.

16. The method as in claim 1, further comprising reading out the video information stored in the second memory means and displaying the read video information on display means.

17. A system for storing video information comprising:
a control unit; and
a plurality of communication paths connected to the control unit; and
a plurality of first memory means; and
a second memory means connected to the control unit;
wherein each of the first memory means are disposed within at least one of the communication paths, and
wherein the first memory means are arranged and constructed to store video information that is received by the first memory means via the communication paths; and
wherein the second memory means are arranged and constructed to store the video information read from the first memory means via the control unit; and
wherein the control unit is arranged and constructed to read the video information stored in the first memory means and to transmit the read video information to the second memory means.

18. A system as in claim 17, wherein the control unit is arranged and constructed to read the video information from the first memory means in quantities of first units.

19. The system as in claim 18, wherein each first unit is a predetermined number of image frames.

20. The system as in claim 17, wherein the control unit is arranged and constructed to allocate addresses to the video information read from the first memory means.

21. The system as in claim 17, wherein the second memory means comprises a hard disk drive.

22. The system as in claim 17, further comprising:
a third memory means arranged and constructed to store the video information read from the first memory means; and
wherein the control unit is further arranged and constructed to read the video information stored in the third memory means in quantities of second units and to store the read video information from the third memory means in the second memory means.

23. The system as in claim 22, wherein each second unit is a predetermined number of image frames.

24. The system as in claim 23, wherein the control unit is arranged and constructed to determine the predetermined number of image frames so as to correspond to a storage region of the second memory means.

25. The system as in claim 24, wherein the second memory means comprises a hard disk drive and a third memory means comprises RAM.

26. The system as in claim 17, wherein the video information represents images captured by a plurality of cameras.

27. The system as in claim 26, wherein the video information comprises a first video information of an image in front of an automobile and a second video information of an image of an interior of the automobile.

28. The system as in claim 17, further comprising compression means disposed in the communication paths and arranged and constructed to compress the video information before the video information is received by the first memory means.

29. The system as in claim 28, further comprising decompression means arranged and constructed to uncompress the video information, wherein the control unit is arranged and constructed to read out compressed video information stored in the second memory means and to uncompress the read video information by the decompression means.

30. The system as in claim 29, further comprising display means arranged and constructed to display the uncompressed video information.

31. The system as in claim 17, wherein the control unit is arranged and constructed to read the video information stored in the second memory means and to display the read video information on display means.
